(19) United States
(12) Patent Application Publication
(10) Pub. No.: US 2020/0413147 A1
(43) Pub. Date: Dec. 31, 2020

(54) METHOD AND APPARATUS FOR PROXIMITY-BASED PLAY OF PREFERRED CONTENT

(71) Applicant: Rovi Guides, Inc., San Jose, CA (US)

(72) Inventors: Vikram Makam Gupta, Bangalore (IN); Vishwas Sharadanagar Panchaksharaiah, Tumkur District (IN)

(21) Appl. No.: 16/455,384

(22) Filed: Jun. 27, 2019

(51) Int. Cl. H04N 21/472; H04N 21/485; H04N 21/6587; H04N 21/442

(52) U.S. Cl. CPC H04N 21/47202; H04N 21/44213; H04N 21/6587; H04N 21/4852

(57) ABSTRACT

Systems and methods for altering playback of certain content based on the proximity of the playback device to a user. If a first user's favored content is playing on another user's nearby device, playback volume of the content is increased. In this manner, the first user more readily perceives his or her favorite content even though it is playing on a device not his or her own.

### BACKGROUND

Embodiments of the disclosure relate generally to electronic media entertainment systems. More specifically, embodiments of the disclosure relate to electronic media entertainment systems for proximity-based play of preferential content.

### SUMMARY

The wide availability and selection of digital content, combined with the large number of electronic devices available for its playback, allows users great flexibility in where and how they may consume content. There are often limitations imposed on this flexibility, though. For example, content providers often allow purchased content to be played on only a limited number of devices. Authorized devices may not be accessible to users at all times. Similarly, not every device supports every content provider application. Devices without a particular content provider application cannot play that provider's content.

Accordingly, to overcome the problems and limitations of incomplete access to content, systems and methods are described herein for a computer-based process that determines when a user's preferred content is playing nearby, and increases its volume so it can be more readily perceived by the user. For example, devices within audible distance of a user are monitored, to determine whether they are playing content preferred by that user. If a device plays content preferred by that user, the content is increased in volume so that the user may more readily listen to his or her preferred content. In this manner, users may hear content they enjoy, even when it is played by others nearby and even when they themselves are not currently able to play their content.

Accordingly, to overcome the problems and limitations of insufficient access to content, systems and methods are described herein for a computer-based process that determines when the user's favorite content is playing on other users' devices and increases the relative volume of this content accordingly. In one embodiment, when a user's favorite content is playing on other users' devices that are within earshot but not too close, the content is played louder so that the user can perceive and enjoy his or her favored content. If the content is played very close to the user, there is no need to increase its volume, as the user can hear it anyway.

To carry out this process, a system may monitor devices near a user to determine whether they are playing the user's favorite content. The system may also determine whether any of these nearby devices are close but not too close to the user, i.e., whether any device playing a user's favorite content is not already within earshot of the user but would be within earshot if the content's volume were increased. If this is the case, the system can increase the volume of the content so that it is perceptible by the user. The system can also, or alternatively, initiate playback of this content on another nearby device that is perceptible by the user. In this manner, a user's favored content may be viewed or listened to even though the user may not have access to that content on his or her own device at that particular time.

If the device playing favored content is too close to the user, i.e., the device is already so close that the user can hear it, the system can optionally decrease the output volume of the user's own device, so that the user may more readily perceive his or her favored content. That is, even though the favored content may not be increased in volume (due to being close to the user already), the user's own device is quieted to allow the user to more easily hear content that he or she enjoys. In similar manner, content playback on the user's device may instead be paused, so that the user more readily hears his or her nearby favored content.

As mentioned above, playback of favored content may be initiated on another device near the user. That is, when the system determines that favored content is playing within earshot of the user, playback may instead, or in addition, be initiated on another device near the user. For example, favored content may be initiated on a nearby smart speaker. To accomplish this, the system may first determine whether the nearby device is permitted to play the favored content currently being played within earshot of the user, such as by verifying that the number of devices on which the content is permitted to be played has not yet been exceeded. If the content is not permitted on the nearby device, e.g., the content has already been played on the permitted number of devices and no further devices of the user may play the content, the system may act as above, increasing the volume of the favored content already being played rather than initiating playback on another device. Conversely, if the favored content is permitted on a nearby device, playback of the favored content can be initiated on that device.

It is also noted that the system can increase the relative volume of any type of content, including audio content and video content. For example, the system may increase the volume of audio content such as music. The system may also increase the volume of video content, such as a movie, a video game, or any other content with a visual component. The content may also have both audio and video components together.

An issue may arise when the user is already playing favored content on his or her own device. That is, a situation may occur in which a user's favored content may be detected on another nearby device at the same time that the user is playing other favored content on his or her own device. For instance, a user's list of favored content may include both song A and song B, and song B may be detected on another nearby device while, at the same time, the user is playing song A on his or her own device. In this case, the system may leave both device volumes unchanged, as the user is already enjoying favored content. Accordingly, the system may check whether a user's favored content is playing both on a nearby device and on the user's own device. If favored content is playing on only the nearby device, the system may act as above, increasing the volume of the favored content on the nearby device, decreasing the volume of the user's device, pausing the user's device, or the like. On the other hand, if favored content is playing on both the nearby device and the user's device, volumes of the nearby device and the user's device may be left unchanged.

### BRIEF DESCRIPTION OF THE FIGURES

The above and other objects and advantages of the disclosure will be apparent upon consideration of the following detailed description, taken in conjunction with the accompanying drawings, in which like reference characters refer to like parts throughout, and in which:

FIG. 1 illustrates an exemplary process of proximity-based play of preferred content in accordance with embodiments of the disclosure;

FIG. 2 is a block diagram illustration of a system for implementing the process of FIG. 1;

FIG. 3 is a generalized embodiment of illustrative content consumption devices constructed for use according to embodiments of the disclosure;

FIG. 4 is a generalized embodiment of an illustrative content direction device constructed for use according to embodiments of the disclosure; and

FIGS. 5 and 6 are a flowchart illustrating process steps for proximity-based play of preferred content in accordance with embodiments of the disclosure.

### DETAILED DESCRIPTION

In one embodiment, the disclosure relates to systems and methods for altering playback of certain content based on the proximity of the playback device to a user. If a user's favorite content is playing on another user's nearby device, playback volume of the content can be increased so that the user more readily perceives his or her favorite content even though it is playing on a device not his or her own.

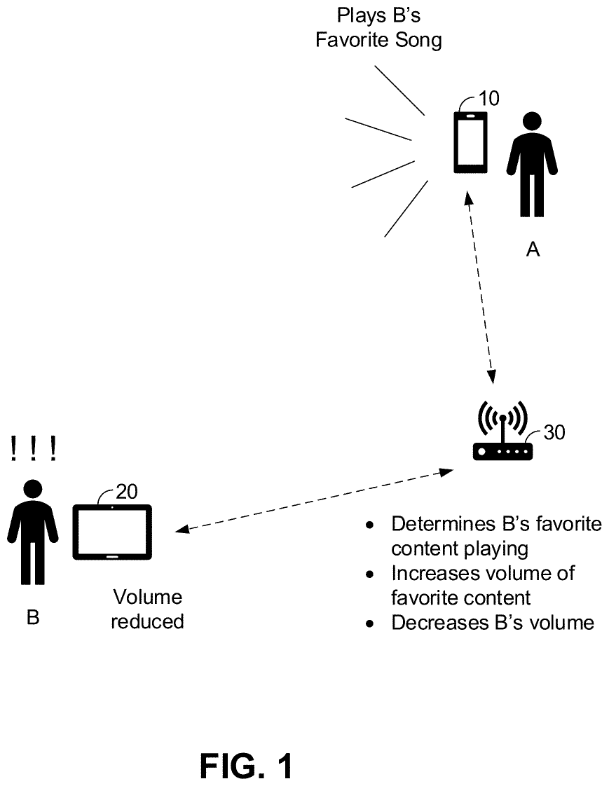

FIG. 1 illustrates an exemplary process of proximity-based play of preferred content in accordance with embodiments of the disclosure. Here, first device 10 and second device 20 are in electronic communication with a content direction device 30. First device 10 is used by user A to play content, and second device 20 is used by user B. The content direction device 30 monitors the content being played by each device 10, 20, in this case to determine whether its content is favorite content of user B. This determination may be performed according to a stored user profile of user B, as further described below. The content direction device 30 also determines the location of each device 10, 20.

If the content direction device 30 determines that device 10 is playing content listed as favored or favorite content in user B's stored user profile, and that device 10 is not proximate to device 20 (i.e., not proximate to user B) but likely would be within user B's hearing if its volume were increased by some reasonable amount, the content direction device 30 increases the output volume of device 10 so that user B may hear his or her favored content. This allows users such as user B to enjoy their favored content even when they are not currently playing it, or are not permitted to play it on their own device 10.

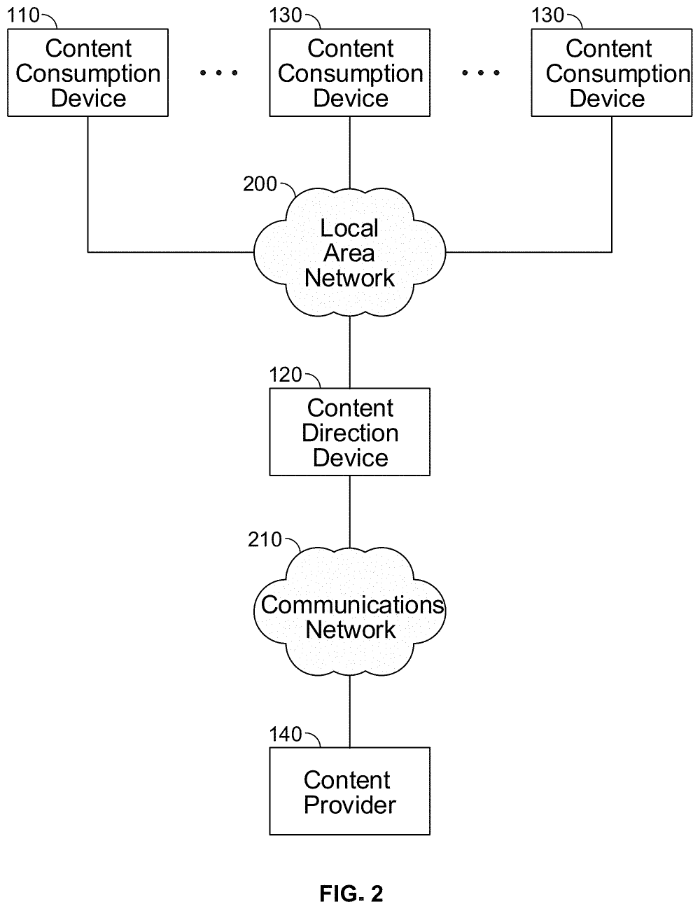

FIG. 2 is a block diagram representation of a system for implementing the process of FIG. 1, presented for further illustration. Any number of content consumption devices 110 and 130 may be in communication with content direction device 120 through, for example, a local area network 200. The content direction device 120 is in electronic communication with content provider 140 through communications network 210. As one example, the content consumption devices 110 and 130, local area network 200, and content direction device 120 may all be situated within a local area, e.g., within various rooms of a home or office. The content provider 140 may be a remotely located server at a content provider site, and the communications network 210 may be the public Internet. Alternatively, the content provider 140 may be situated within the local area and may be, for example, a local content storage and streaming application on a local computer including any of the above computing devices, or even a storage and display application within the content direction device 120 itself. Multiple content providers 140 may be in communication with content direction device 120 through communications network 210. Content devices 10, 20 may be examples of content consumption devices 110, 130, and content direction device 30 may be an example of content direction device 120.

A user may be watching a show or playing other content on first content consumption device 110, at which point the content provider 140 is providing a stream of the show or other content through communications network 210 to content direction device 120. The content direction device 120 in turn receives this stream and directs it to device 110 over local area network 200. When another user requests another show or other stream on one of the second content consumption devices 130, the content direction device 120 receives the stream from one content provider 140 and directs the stream to the second content consumption device 130. In this manner, content may be streamed to multiple different devices 110, 130. The content direction device 120 also monitors these content streams to determine whether any of them are favored content of a user, determines the locations of devices 110, 130, and determines whether favored content of a user is being streamed to a device in earshot but not proximate (i.e., near but not too near) to that user's device 110, 130. When these conditions are met, the content direction device 120 directs the content consumption device 110, 130 playing this favored content to increase its playback volume. In other embodiments, and as described above, the content direction device 120 may also decrease the volume of the user's device 110, 130 so that the user may more readily hear his or her nearby favored content playing, and/or may pause the user's device 110, 130.

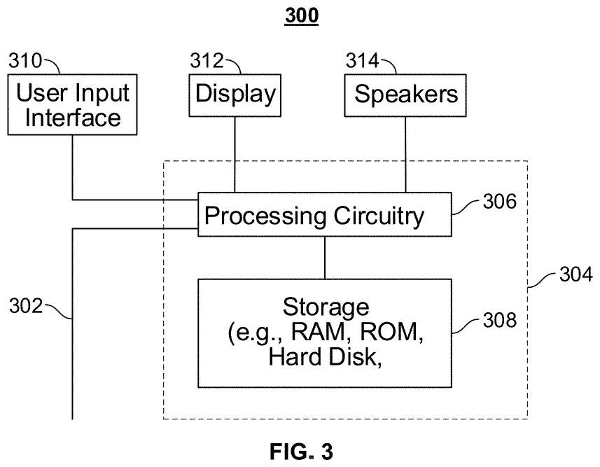

The content consumption devices 110, 130, e.g., devices 10, 20, may be any devices capable of receiving streamed content and displaying the content for users. For example, content consumption devices 110, 130 may be digital TVs, laptop computers, smartphones, tablet computers, or the like. FIG. 3 shows a generalized embodiment of an illustrative user equipment device 300 that may serve as a content consumption device. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for receiving streamed content and executing its display, such as executing application programs that provide interfaces for content providers 140 to stream and display content.

Control circuitry 304 may thus include communications circuitry suitable for communicating with a content provider 140 server or other networks or servers. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be included. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

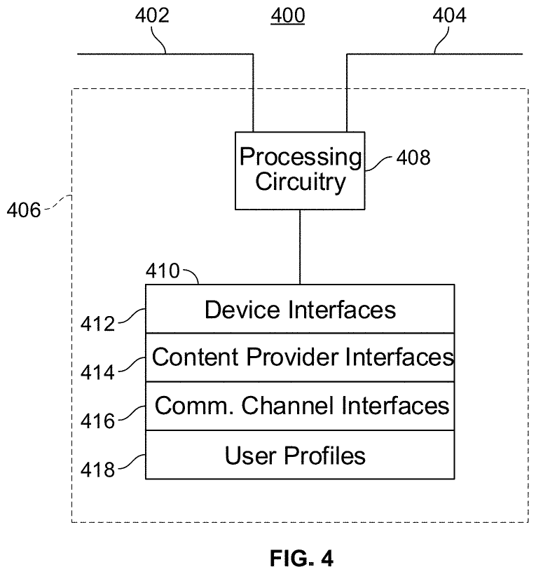

FIG. 4 is a generalized embodiment of an illustrative content direction device 120 constructed for use according to embodiments of the disclosure. Here, device 400 may serve as a content direction device. Device 400 may receive content and data via I/O paths 402 and 404. I/O path 402 may provide content and data to the various content consumption devices 110 and 130, while I/O path 404 may provide data to, and receive content from, one or more content providers 140. Like the user equipment device 300, the device 400 has control circuitry 406 which includes processing circuitry 408 and storage 410. The control circuitry 406, processing circuitry 408, and storage 410 may be constructed, and may operate, in similar manner to the respective components of user equipment device 300.

Storage 410 is a memory that stores a number of programs for execution by processing circuitry 408. In particular, storage 410 may store a number of device interfaces 412, content provider interfaces 414, communication channel interfaces 416 for communicating with various applications that provide communication channels, and user profiles 418. The device interfaces 412 are interface programs for handling the exchange of commands and data with the various content consumption devices 110, 130. Content provider interfaces 414 are interface programs for handling the exchange of commands and content streams with various content providers 140, and are programmed to exchange commands and content similar to a corresponding application program on a content consumption device 110, 130. A separate interface 414 may exist for each different content provider 140 that has its own format for commands or content. Communication channel interfaces are interface programs for handling the exchange of commands and data with various communication channel application programs. A separate interface 416 may exist for each different communication channel application program that the content direction device 120 may interface with. User profiles 418 are stored user profiles corresponding to viewers or users of the content consumption devices 110, 130. User profiles 418 are known, and can contain favored content of their users. This favored content may be determined in any manner, such as by user entry of favored content they wish to hear when it is playing on others' nearby devices, automated determination of favored content from profiles of content the user has requested in the past, and the like. Content, including favored content, can also be any form of content, including audio content such as podcasts and e-books, video content such as videos, movies, audio and video content, and the like.

The device 400 may be any electronic device capable of receiving content streams and transferring them to one or more content consumption devices 110, 130. For example, the device 400 may be a networked in-home smart device connected between a home modem and various content consumption devices 110, 130. The device 400 may alternatively be a laptop computer or desktop computer configured as above.

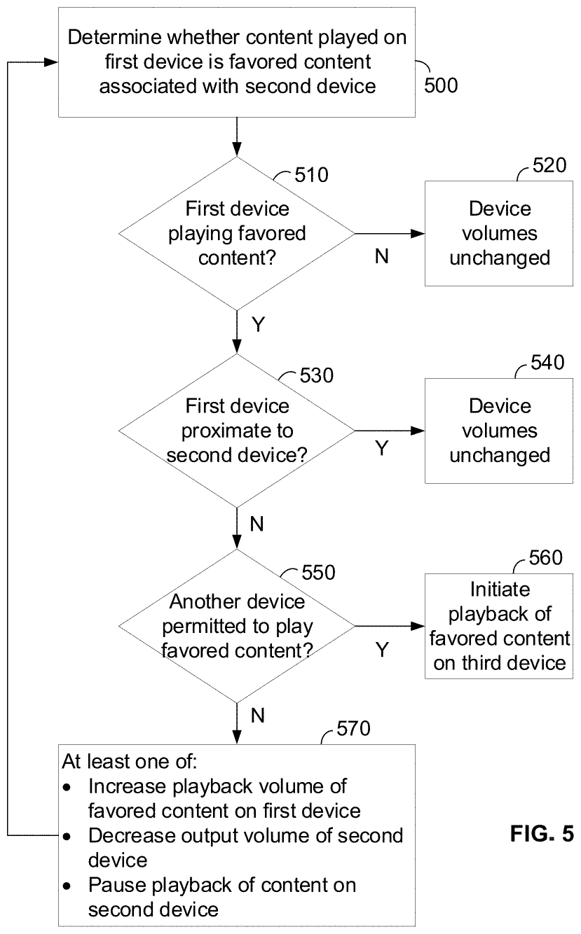

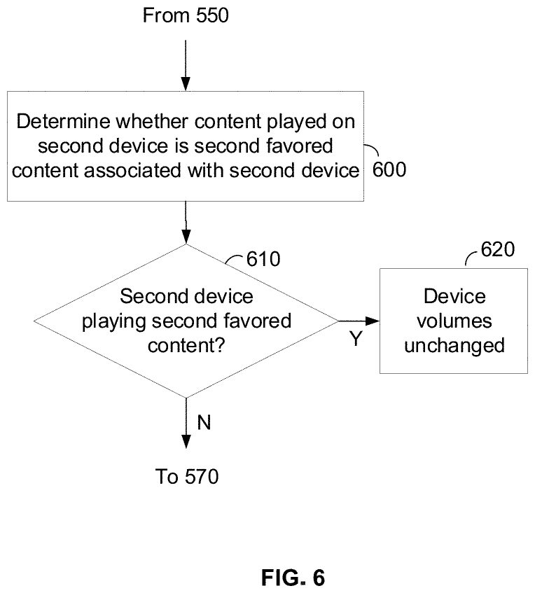

FIGS. 5 and 6 are a flowchart illustrating process steps for proximity-based play of preferred content in accordance with embodiments of the disclosure. Initially, content direction device 120 determines whether content played on a first device is favored content associated with a second device (Step 500). For example, content direction device 120 determines whether a first device 110 is playing favored content associated with a second device 130 (Step 510). To accomplish this, the content direction device 120 compares the content playing on first device 110 to the user profile 418 associated with second device 130, to determine whether the content playing on first device 110 is listed in the user profile's list of favorite content. If the content currently playing on first device 110 is not on the user profile's list of favorite content, then the content is not deemed to be content that the user of second device 130 is particularly interested in hearing, and the volumes of devices 110 and 130 are left unchanged (Step 520).

On the other hand, if device 110 is playing content that appears in the user profile's list of favored content, then a check is made to determine whether the first device 110 is proximate to the second device 130 (Step 530). Proximity may be determined in any manner. For example, the content direction device 120 may determine a position of each device 110, 130 if the devices 110, 130 each have access to a position determination service such as an internal global positioning system (GPS) capability or the like. In such a case, each device 110, 130 may relay its position to the content direction device 120 which may then determine the distance between the two devices 110, 130. Alternatively, the content direction device 120 may estimate the position of each device 110, 130 according to whether the devices 110, 130 are in communication with the same WiFi network, or are in communication with different WiFi networks that are both known to be, for example, in the same residence or in the same office.

As above, the content direction device 120 determines whether the devices 110, 130 are near each other but not too near each other, as very close devices 110, 130 will be overheard by users without increase in volume, and very distant devices 110, 130 will not be heard by their users regardless of how much their volumes are increased. Accordingly, embodiments of the disclosure act to increase the volume, or otherwise increase the perceptibility of, favored content within a range of distances between devices 110 and 130. This range may be any suitable range. An exemplary lower bound for this range may be any range in which a typical playback volume of a device 110 is readily perceived by other users, e.g., 2-10 feet, within the same vehicle or the same room, on the same floor of a structure, within the same office, or the like. An exemplary upper bound for this range may be any maximum range at which a device 110 is readily perceived by other users when its volume is increased to a reasonable magnitude, e.g., 10-30 feet, within different rooms such as adjacent rooms of the same structure, in different rooms or different floors of the same residence, in different portions of the same office, or the like. Embodiments of the disclosure contemplate any range of distances within which perceptibility increase of favored content may be implemented.

If the devices 110, 130 are determined to be too close, i.e., below an above range of distances, the content direction device 120 determines that the devices 110, 130 are proximate to each other and no volume adjustment is performed on either device 110, 130 (Step 540). Conversely, if the devices 110 and 130 are determined to be separated from each other by a distance within a range above, the content direction device makes another check to determine whether another nearby device is permitted to play the favored content (Step 550). This entails both determining the presence of a suitable nearby device, and determining whether this nearby device is permitted to play the favored content. The content direction device 120 may determine the presence of a nearby device, which can be any other device 130 in communication with device 120, by any method, such as any of the methods described above. For instance, if another device 130 is GPS enabled, its position may be requested and the distance between that device 130 and device 110 may be determined. Alternatively, the location of device 130 may be estimated according to its presence on an identical or adjacent WiFi network as device 110.

Determination of whether a nearby device 130 is permitted to play the favored content may also be determined in any manner. As one example, permissions may be stored in user profiles 418 and accessed by content direction device 120. As another example, content direction device 120 may query content providers 140 to determine whether the device 130 is authorized to play or stream the favored content.

If the nearby device 130 is permitted to play the favored content, content direction device 120 initiates a new stream of the favored content on that device 130 (Step 560). This stream may be in addition to, or instead of, the favored content already streaming to previous device 130 (e.g., the favored content already being played by user A in the example of FIG. 1). Conversely, if the nearby device 130 is not permitted to play the favored content, the content direction device 120 instead must increase the perceptibility of the favored content by one of the approaches listed above, such as by increasing the volume of the favored content already streaming on first device 110, decreasing the output volume of the second device 130, or pausing playback of content on the second device 130 (Step 570).

FIG. 6 illustrates additional process steps that can be performed between Steps 550 and 570 of FIG. 5. Thus, once it is determined that no nearby device 130 exists, or none is permitted to play favored content, the content direction device 120 can determine whether content played on second device 130 (i.e., the device of the user whose favored content is playing, or user B of FIG. 1) is also favored content of the user (Step 600). That is, the content direction device 120 checks to determine whether user B happens to already be playing his or her favored content while other favored content is also playing on a nearby device.

The content direction device 120 can perform the check of Step 600 by referring to the user's user profile 418. That is, content direction device 120 can check the user profile 418 corresponding to second device 130 for the both the content playing on first device 110 and the content playing on second device 130. If both the content playing on first device 110 and that playing on second device 130 appear on the favored content of user profile 418, then the user is listening to one selection of his or her favored content at the same time as another selection is playing on another device within earshot. In this situation, it is deemed that the user should not be disturbed, as he or she is already listening to favored content. Accordingly, device volumes remain unchanged (Step 610). That is, the nearby device playing favored content is not increased in volume. Conversely, if the user is not playing his or her favored content, then the only favored content he or she can hear at that time is that content being played on a nearby device 130. Thus, the process proceeds to Step 570 where perceptibility of the content is increased for the user, such as by increasing the volume of the favored content already streaming on first device 110, decreasing the output volume of the second device 130, or pausing playback of content on the second device 130.

One of ordinary skill in the art will observe that perceptibility of favored content can be increased in other ways besides those strictly listed above. For example, in one embodiment, instead of increasing perceptibility when devices 110, 130 are within a range of distances from each other, perceptibility may be increased when devices 110 and 130 are within a predetermined distance from each other. That is, favored content volume or the like can be increased when devices 110 and 130 are less than some distance from each other, rather than within a range of distances. In this example, Step 530 would be replaced by a check to determine whether the distance between the user's device 110 and the device 130 playing his or her favored content is less than a predetermined distance. If the devices are beyond this predetermined distance from each other, the process would proceed to Step 540 and the favored content would not be increased in volume. On the other hand, if the devices are within this predetermined distance from each other, the process would proceed to Step 550. Device locations and distances from each other can be determined in any manner, such as by any of the methods described above. Similarly, the predetermined distance can be any distance, such as any predetermined length (e.g., 10 feet, 50 feet, or the like), any distance within the same room, any distance within adjacent rooms, any distance within the same office, vehicle, or designated area, or the like.

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, embodiments of the disclosure contemplate any type of content, audio, video, or otherwise, that is increased in perceptibility at any detected distance from the user. Similarly, perceptibility increase can be an increase in volume of favored content, a decrease in volume of other content being played at the same time, and/or a pausing of such other content. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

1. A method for preferential playback of favored content, the method comprising:
determining whether content played on a first device is favored content associated with a second device;
determining a distance between the first device and the second device;
if the content played on the first device is the favored content and based on the distance between the first device and the second device, performing, by a third device, at least one of incrementally increasing a volume of playback of the favored content based on the distance between the first device and the second device or initiating and incrementally increasing a volume of playback of the favored content on a fourth device.

2. The method of claim 1, further comprising, if the content played on the first device is the favored content and the first device is proximate to the second device, decreasing a volume of output of the second device.

3. The method of claim 1, further comprising, if the content played on the first device is the favored content and the first device is proximate to the second device, pausing playback of content on the second device.

4. The method of claim 1, further comprising determining whether another device is permitted to play the favored content while the favored content is played on the first device.

5. The method of claim 4, wherein the performing further comprises increasing the volume of playback of the favored content if another device is not permitted to play the favored content while the favored content is played on the first device.

6. The method of claim 4, wherein the performing further comprises initiating playback of the favored content on the fourth device if another device is permitted to play the favored content while the favored content is played on the first device.

7. The method of claim 1, wherein at least one of the content played on the first device or the favored content is audio content.

8. The method of claim 1, wherein at least one of the content played on the first device or the favored content is video content.

9. The method of claim 1, wherein the favored content is first favored content, the method further comprising determining whether content played on the second device is second favored content associated with the second device.

10. The method of claim 9, wherein the performing further comprises performing at least one of increasing a volume of playback of the favored content or initiating playback of the favored content on the fourth device if the content played on the first device is the favored content, the first device is proximate to the second device, and the content played on the second device is not the second favored content.

11. A system for preferential playback of favored content, the system comprising:
a storage device; and
control circuitry configured to:
determine whether content played on a first device is favored content associated with a second device;
determine a distance between the first device and the second device; and
if the content played on the first device is the favored content and based on the distance between the first device and the second device, perform, by a third device, at least one of incrementally increasing a volume of playback of the favored content based on the distance or initiating and incrementally increasing a volume of playback of the favored content on a fourth device.

12. The system of claim 11, wherein the control circuitry is further configured to, if the content played on the first device is the favored content and the first device is proximate to the second device, decrease a volume of output of the second device.

13. The system of claim 11, wherein the control circuitry is further configured to, if the content played on the first device is the favored content and the first device is proximate to the second device, pause playback of content on the second device.

14. The system of claim 11, wherein the control circuitry is further configured to determine whether another device is permitted to play the favored content while the favored content is played on the first device.

15. The system of claim 14, wherein the performing further comprises increasing the volume of playback of the favored content if another device is not permitted to play the favored content while the favored content is played on the first device.

16. The system of claim 14, wherein the performing further comprises initiating playback of the favored content on the fourth device if another device is permitted to play the favored content while the favored content is played on the first device.

17. The system of claim 11, wherein at least one of the content played on the first device or the favored content is audio content.

18. The system of claim 11, wherein at least one of the content played on the first device or the favored content is video content.

19. The system of claim 11, wherein the favored content is first favored content, the method further comprising determining whether content played on the second device is second favored content associated with the second device.

20. The system of claim 19, wherein the performing further comprises performing at least one of increasing a volume of playback of the favored content or initiating playback of the favored content on the fourth device if the content played on the first device is the favored content, the first device is proximate to the second device, and the content played on the second device is not the second favored content.

21-30. (canceled)
